(19) United States
(12) Patent Application Publication
(10) Pub. No.: US 2025/0068188 A1
(43) Pub. Date: Feb. 27, 2025

(54) CARGO CONTAINER SYSTEM AND METHODS OF USING SAME

(71) Applicants: VX Aerospace Corporation, Morganton, NC (US); North Carolina State University, Raleigh, NC (US)

(72) Inventors: Robert Skillen, Morganton, NC (US); Matthew Bryant, Raleigh, NC (US); Ashok Gopalarathnam, Apex, NC (US); Brian Riskas, Fort Worth, TX (US); Hari Kiran, Raleigh, NC (US); Michael Hughes, Raleigh, NC (US); Aditya Srihari, Charlotte, NC (US)

(21) Appl. No.: 18/813,835

(22) Filed: Aug. 23, 2024

Related U.S. Application Data
(60) Provisional application No. 63/578,305, filed on Aug. 23, 2023.
(60) Provisional application No. 63/535,616, filed on Aug. 31, 2023.

(51) Int. Cl. G05D 3/20; B62D 33/10; B64D 9/00; B65D 88/14

(52) U.S. Cl. CPC G05D 3/20; B62D 33/10; B64D 9/00; B65D 88/14

(57) ABSTRACT

A cargo container system, comprising: a vehicle with a cargo compartment; a cargo container configured to fit within the cargo compartment; and, a weight balance adjustment mechanism, comprising at least one of a load sensor and a position sensor, configured to adjust the position of the cargo container within the cargo compartment using data received from the at least one of a load sensor and a position sensor

### RELATED APPLICATION/S

This application claims the benefit of priority under 35 USC § 119(e) of U.S. Provisional Patent Application No. 63/578,305 filed Aug. 23, 2023 and of U.S. Provisional Patent Application No. 63/535,616 filed Sep. 1, 2023, the contents of which are incorporated herein by reference in their entireties.

### FIELD OF THE INVENTION

The present invention, in some embodiments thereof, relates to transportation and, more particularly, but not exclusively, to a cargo transport system.

### SUMMARY OF THE INVENTION

According to an aspect of some embodiments of the present invention there is provided a cargo container system, comprising: a vehicle with a cargo compartment; a cargo container configured to fit within the cargo compartment; and, a weight balance adjustment mechanism, comprising at least one of a load sensor and a position sensor, configured to adjust the position of the cargo container within the cargo compartment using data received from the at least one of a load sensor and a position sensor.

In an embodiment of the invention, the vehicle is an aircraft.

In an embodiment of the invention, the cargo container is a box having an interior space with at least one door for accessing the interior space.

In an embodiment of the invention, the cargo container is a pallet.

In an embodiment of the invention, the weight balance adjustment mechanism comprises a controller for processing the data and/or at least partially automatically controlling the weight balance adjustment mechanism.

In an embodiment of the invention, the cargo container further comprises a user interface configured to provide information regarding the system and control of the system to a user.

In an embodiment of the invention, the cargo container comprises a plurality of wheels on an underside of the cargo container.

In an embodiment of the invention, the wheels are attached to the cargo container by folding and/or retractable and expandable struts.

In an embodiment of the invention, the wheels are motorized.

In an embodiment of the invention, the folding and/or retractable/expandable struts are actuated.

In an embodiment of the invention, the weight balance adjustment mechanism is configured to adjust the position of the cargo container while the vehicle is still or in motion based on the data.

In an embodiment of the invention, the at least one of a load sensor and a position sensor is disposed on the vehicle, on the cargo container or both.

In an embodiment of the invention, the system further comprises an integrated power source.

In an embodiment of the invention, the cargo container is at least partially automatically loaded into the cargo compartment.

In an embodiment of the invention, the weight balance adjustment system comprises a screw-based movement mechanism.

In an embodiment of the invention, the system further comprises an electro-mechanical interface between the cargo container and the vehicle.

According to an aspect of some embodiments of the present invention there is further provided a method of using a cargo container system, comprising: placing cargo into a cargo container; inserting the cargo container into a cargo compartment of a vehicle; and, adjusting the weight balance of the cargo container within the cargo compartment using a weight balance adjustment mechanism comprising at least one of a load sensor and a position sensor, configured to adjust the position of the cargo container within the cargo compartment using data received from the at least one of a load sensor and a position sensor.

In an embodiment of the invention, the method further comprises calculating the weight balance state of the cargo container prior to inserting.

In an embodiment of the invention, at least one of inserting and adjusting is performed at least partially automatically.

In an embodiment of the invention, the adjusting is performed using data derived from at least one of the cargo container and the vehicle.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWING(S)

Some embodiments of the invention are herein described, by way of example only, with reference to the accompanying drawings and images. With specific reference now to the drawings in detail, it is stressed that the particulars shown are by way of example, are not necessarily to scale and are for purposes of illustrative discussion of embodiments of the invention. In this regard, the description taken with the drawings makes apparent to those skilled in the art how embodiments of the invention may be practiced.

In the drawings:

FIG. 1A is a perspective view of an aircraft of a cargo container system, in accordance with an embodiment of the invention;

FIGS. 1B-1C show components of the cargo container system, in accordance with embodiments of the invention;

FIGS. 2A-2E are top, perspective, side, front and top (with dimensions) views, respectively, view of an aircraft of a cargo container system, in accordance with an embodiment of the invention;

FIGS. 3A-3C show exemplary specifications, dimensions and performance characteristics of an aircraft of a cargo container system, in accordance with some embodiments of the invention;

FIGS. 4A-4B are flight performance diagrams of an aircraft of a cargo container system, in accordance with an embodiment of the invention;

FIG. 5 is a partial body dimension illustration of an aircraft of a cargo container system, in accordance with an embodiment of the invention;

FIG. 6 is a perspective rear view of an open aircraft of a cargo container system, in accordance with an embodiment of the invention;

FIG. 7 shows exemplary specifications and use scenarios of an aircraft of a cargo container system, in accordance with an embodiment of the invention;

FIG. 8 is a schematic showing exemplary specifications of a smart box of a cargo container system, in accordance with an embodiment of the invention;

FIGS. 9A-9D are a top, perspective, front and side views, respectively, a smart box of a cargo container system, in accordance with an embodiment of the invention;

FIG. 10 is a perspective view of a smart box of a cargo container system, in accordance with an embodiment of the invention;

FIG. 11 is perspective view of a smart box of a cargo container system, in accordance with an embodiment of the invention;

FIGS. 12A-12E show a sequence for placing a smart box into a loading configuration for insertion into an aircraft of a cargo container system, in accordance with an embodiment of the invention;

FIGS. 13-18 show a sequence of loading a smart box into an aircraft of a cargo container system, in accordance with an embodiment of the invention;

FIGS. 19A-19D show additional and/or alternative details, relative to FIG. 13-18, of a sequence of loading a smart box into an aircraft of a cargo container system, in accordance with an embodiment of the invention;

FIGS. 20A-20B show additional and/or alternative details of a sequence of loading a smart box into an aircraft of a cargo container system, in accordance with an embodiment of the invention;

FIG. 21A is a schematic of load balancing in the cargo container system, in accordance with an embodiment of the invention;

FIG. 21B shows a weight balance adjustment mechanism, in accordance with an embodiment of the invention;

FIGS. 22A-22D show top, perspective, side and rear views, respectively, of trim/balance points of the cargo container system, in accordance with an embodiment of the invention;

FIGS. 23A-23B are front and rear perspective views, respectively, of a smart pallet of a cargo container system, in accordance with an embodiment of the invention;

FIG. 24 is an exemplary loading scenario of a smart pallet into an aircraft of a cargo container system, in accordance with an embodiment of the invention;

FIGS. 25A-E show exemplary cargo container system configurations and related performance characteristics, in accordance with embodiments of the invention; and

FIGS. 26A-D shows a tail configuration, in accordance with an embodiment of the invention.

### DESCRIPTION OF SPECIFIC EMBODIMENTS OF THE INVENTION

The present invention, in some embodiments thereof, relates to transportation and, more particularly, but not exclusively, to a cargo transport system.

Before explaining at least one embodiment of the invention in detail, it is to be understood that the invention is not necessarily limited in its application to the details of construction and the arrangement of the components and/or methods set forth in the following description and/or illustrated in the drawings. The invention is capable of other embodiments or of being practiced or carried out in various ways.

Generally speaking, what is described is a “smart” cargo container such as a box (or pallet, such as described below) which interoperates with a vehicle, such as an aircraft (manned or unmanned) or cargo-carrying land vehicle which together form a system such that the cargo box position within the vehicle is automatically moved using a weight balance adjustment mechanism, at any time at rest and/or during transit, in order to achieve a desired weight balance the aircraft, in some embodiments while in flight. This system could primarily find use in the transport of general freight or express air cargo. Potential users of such a system could include Amazon, UPS, FedEx, and USPS, as examples.

It should be understood that the cargo box described herein could be a plurality of cargo boxes of known and/or standard sizes. Additionally, alternatively and/or optionally, the cargo box/pallet could be used with a different type of vehicle in the system, a vehicle which is not an aircraft, such as a land-based vehicle or boat.
Multiple variants possible
   Scale larger/smaller using same architecture
   Smart Pallet
   Integrated human machine interface (HMI)
   Remote touchscreen (stream data to multiple devices)
System reduces dependence on skilled labor/touch labor
   Lower costs
   Faster loading/unloading
   Highly repeatable
Smart Box can be automated to enable fully autonomous operation (move to aircraft, load, unload, move to unloading dock, etc.)

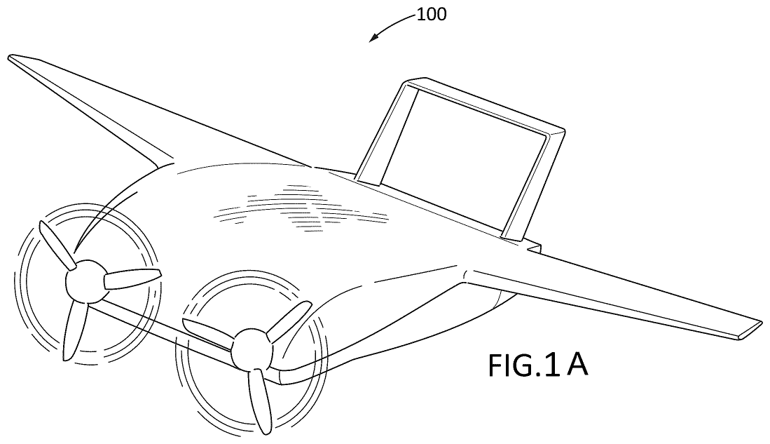

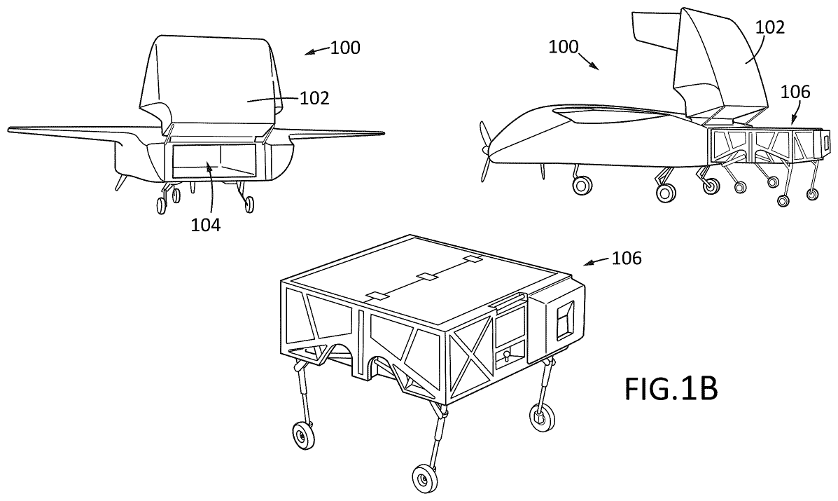

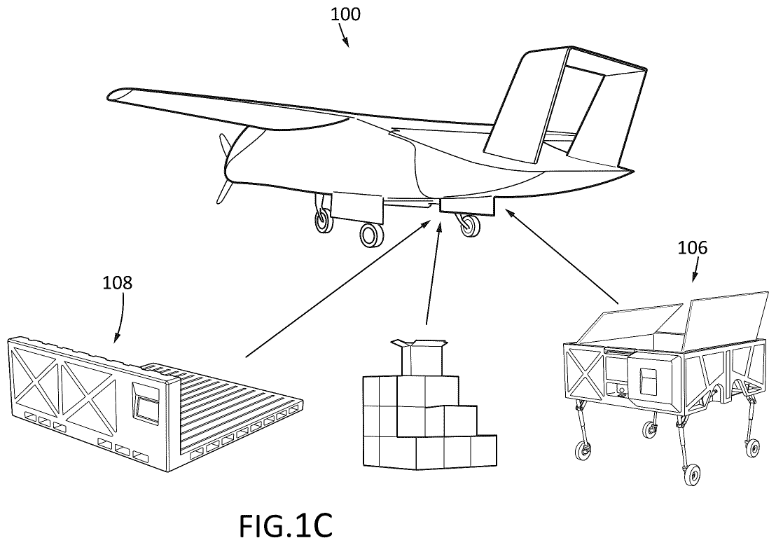

Referring now to the drawings, FIG. 1A is a perspective view of an aircraft 100 of a cargo container system, in accordance with an embodiment of the invention. It can be seen from this view that in some embodiments, the aircraft is a blended wing body form. The blended wing body is useful for accommodating the cargo box (not shown) while also maintaining desirable flight/performance characteristics. Not shown is an optional cockpit in the case of a manned aircraft (it could also be unmanned). While two engines are shown, one engine or more than two engines could be used. The engines could be propeller and/or jet engines, in some embodiments of the invention.

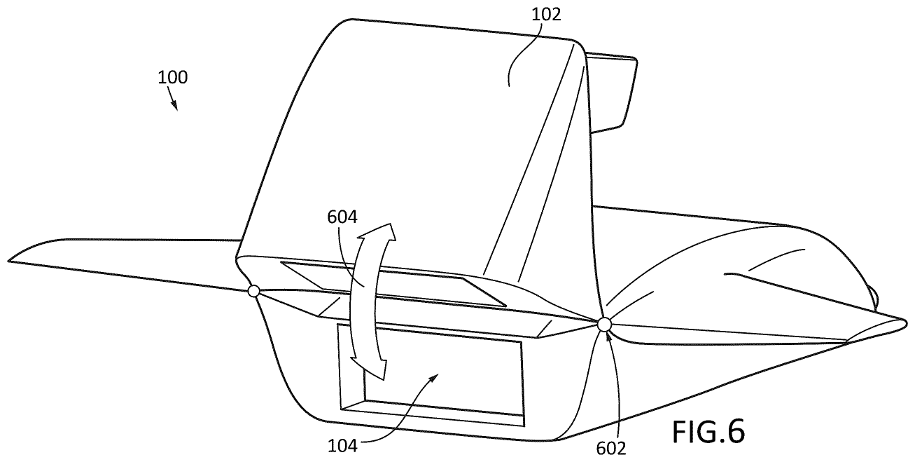

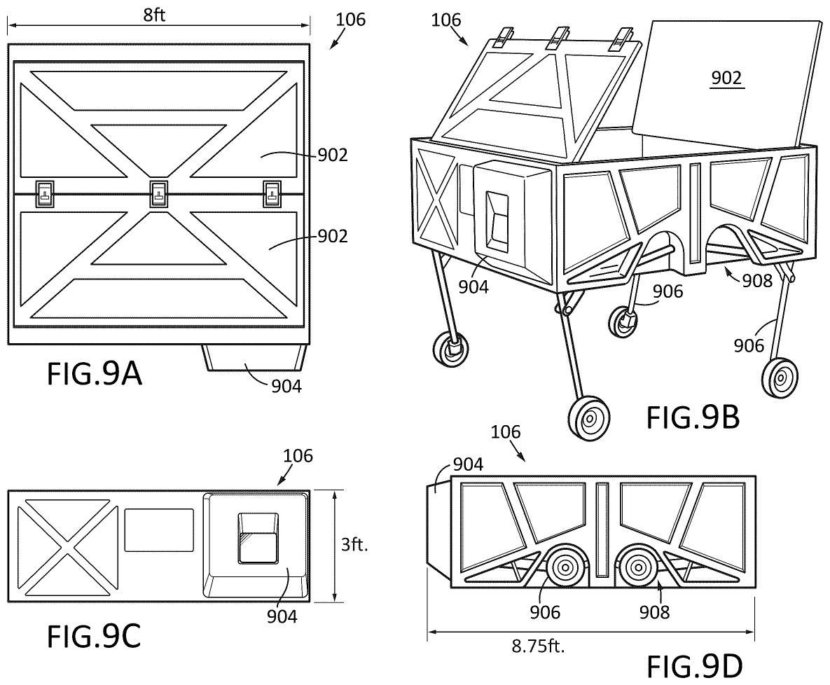

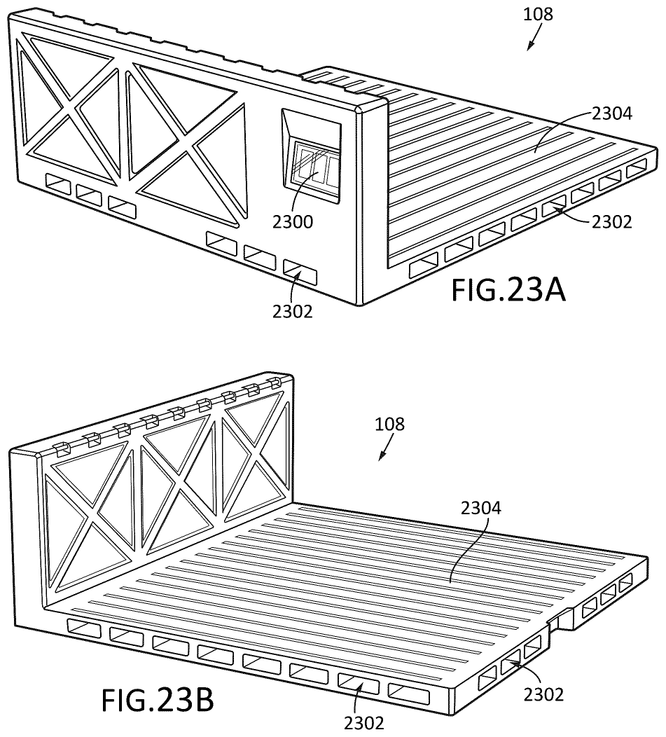

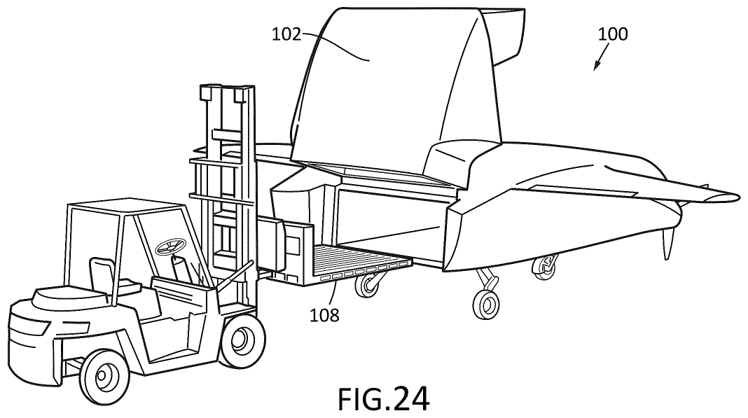

FIGS. 1B-1C show components of the cargo container system, in accordance with exemplary embodiments of the invention. Exemplary embodiments include conventional loading (i.e. at least partially manual, with or without a smart box 106, shown and described in more detail with respect to FIGS. 9A-12E, or smart pallet 108, shown and described in more detail with respect to FIGS. 23A-24) and self-loading or automatic loading, such as described elsewhere herein. In an embodiment of the invention, the aircraft 100 is provided with a cargo compartment 104 which is configured for loading, storage and/or transport of cargo therein. The cargo compartment 104 is accessed, in some embodiments of the invention, by a upwardly-rotating cargo door tail 102 (shown and described in more detail with respect to FIG. 6).

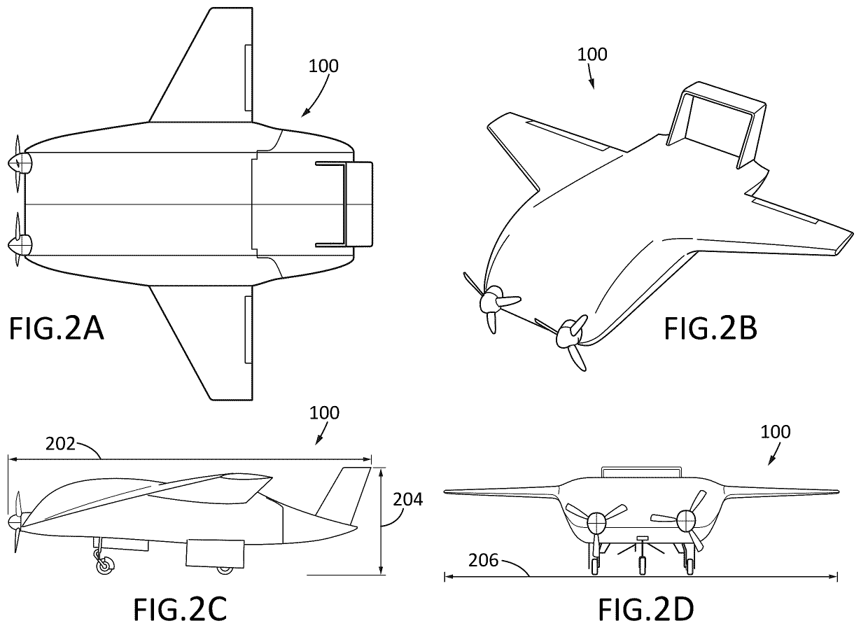

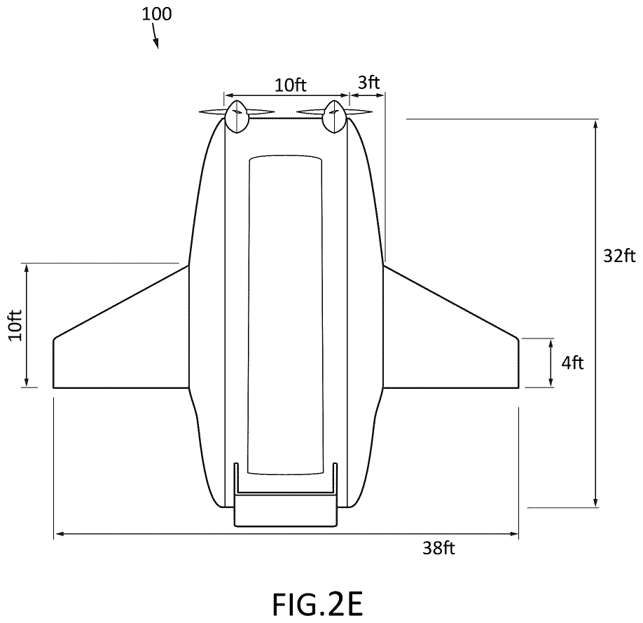

FIGS. 2A-2E are top, perspective, side, front and top (with dimensions) views, respectively, view of an aircraft 100 of a cargo container system, in accordance with an embodiment of the invention. In some embodiments of the invention, the aircraft 100 is about 32 ft (10.64 m) in length 202, is about 11.4 ft (3.48 m) in height (with gear deployed) and the wingspan 206 of the aircraft 100 is about 38 ft (11.58 m). The size dimensions are by way of example only and it should be understand that the dimensions of the aircraft could change depending on mission parameters, including desired range, cargo capacity and if the aircraft 100 is manned or unmanned.

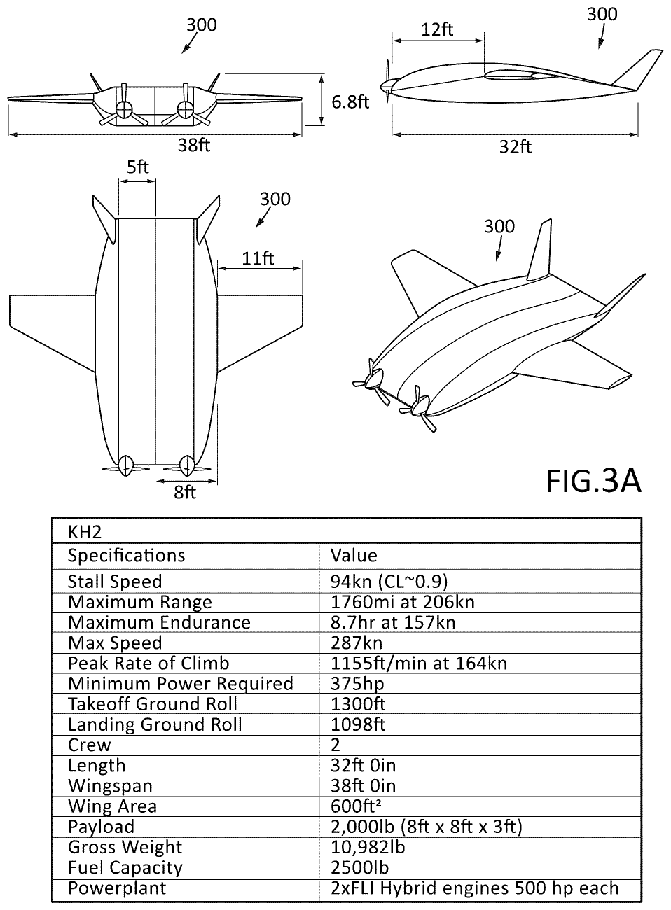

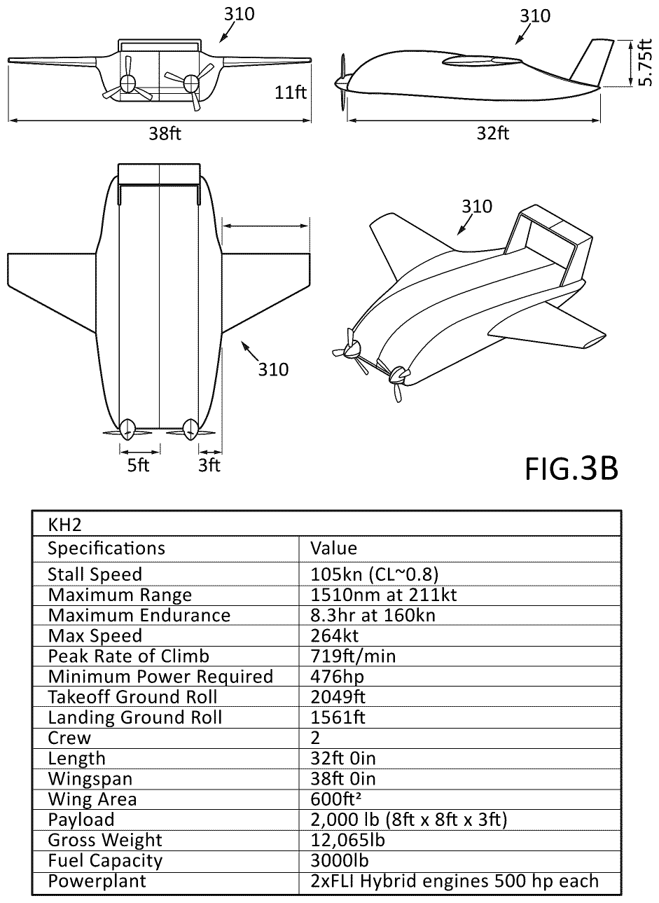

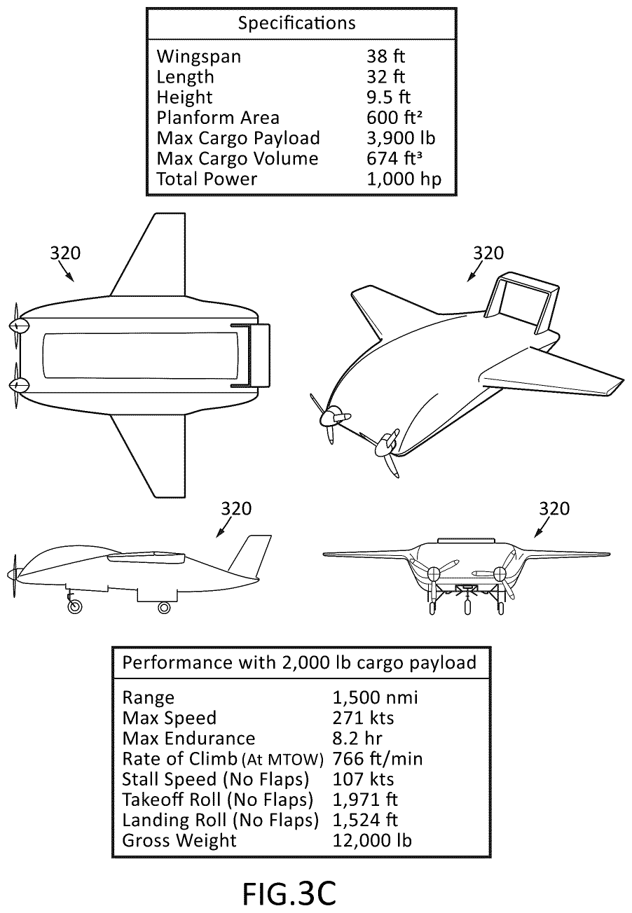

FIGS. 3A-3C show exemplary specifications, dimensions and performance characteristics of different aircraft embodiments 300, 310, 320 of the aircraft 100, respectively, of a cargo container system, in accordance with some embodiments of the invention. It should be understood that these specifications, dimensions and performance characteristics are by way of example only. For example, there could be less or more than 2 crew members. As another example, the stall speed could be higher or lower than 94 or 105 or 107 knots. The size dimensions could be larger or smaller, in one, some or all dimensions, as another example. The number, type and/or horsepower of the engines could also be different than what is shown in FIGS. 3A-3C, for example, the two engines could produce 1500 hp or more in some embodiments of the invention. In some embodiments of the invention, the aircraft uses a hybrid or electric power plant.

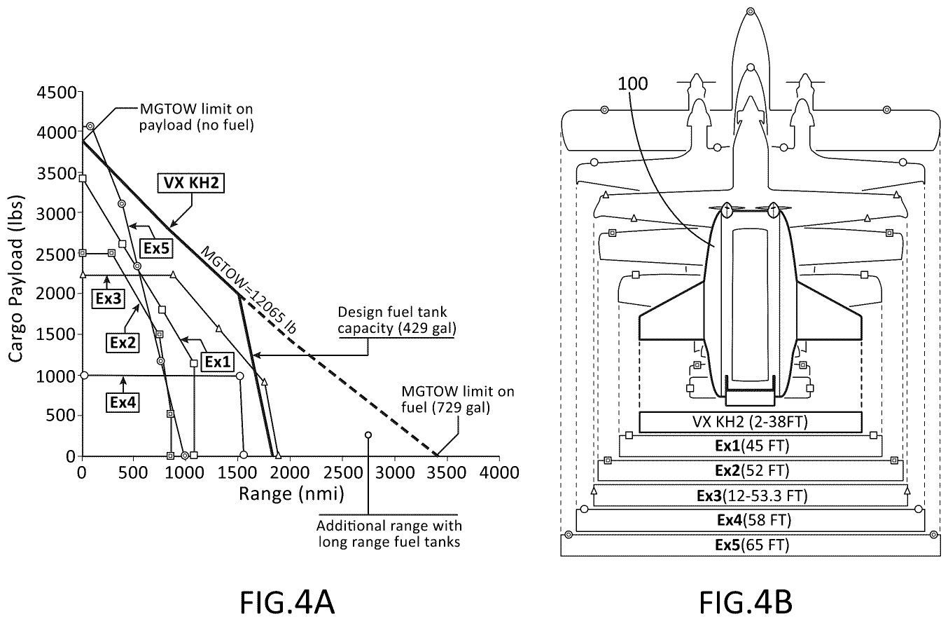

FIGS. 4A-4B are flight performance diagrams of the aircraft 100 of a cargo container system in comparison to other example cargo aircraft in the same industry sector, in accordance with an embodiment of the invention.

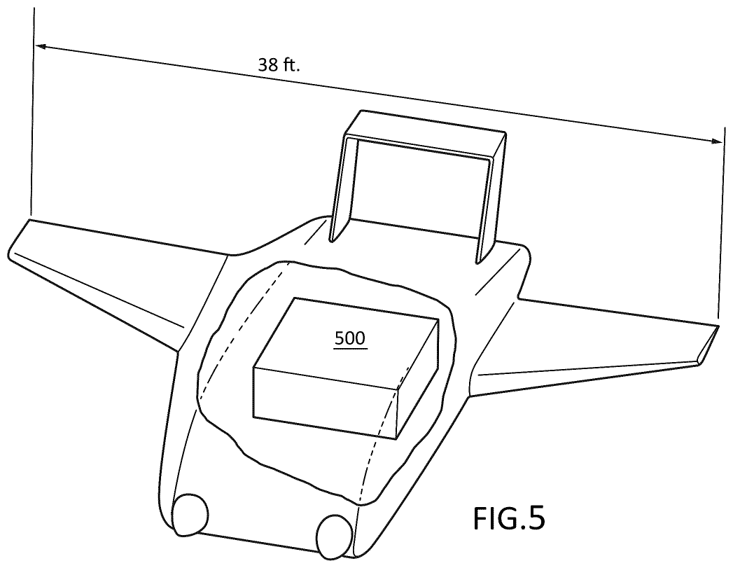

FIG. 5 is a partial body dimension illustration of the aircraft 100 of a cargo container system showing the approximate location of a balanced cargo load 500, in accordance with an embodiment of the invention.

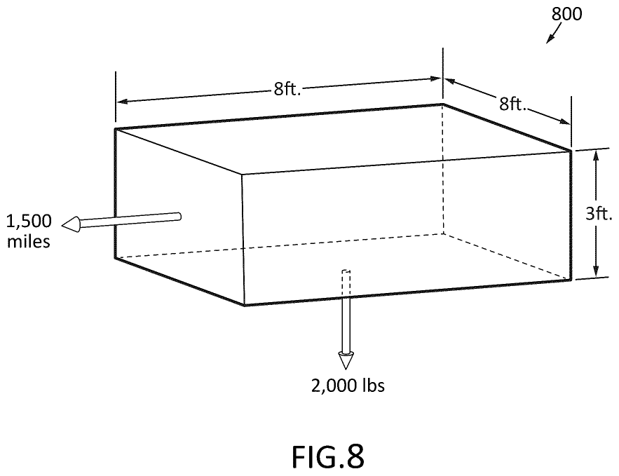

FIG. 6 is a perspective rear view of the aircraft 100 of a cargo container system with the cargo door tail 102 section in an open configuration, in accordance with an embodiment of the invention, where the tail section (or a cargo door thereof) is configured to open (e.g. by pivoting or hinged movement) to allow access to the cargo compartment 104 or compartment within the aircraft body. For example, it is hinged 602 to open/rotate 604 upwardly. In some embodiments, the front of the aircraft is similarly configured alternatively and/or additionally to the rear so that access to the cargo compartment 104 can be achieved from the front. In an embodiment of the invention, the cargo compartment has approximately 300 cu. ft. of volume. This volume could be more or less, depending on the size of the compartment 104 and/or size of the aircraft 100. In some embodiments of the invention, the cargo compartment 104 is generally rectangular in shape. It should be understood that the shape could be something other than rectangular, for example cubic, parallelepiped or trapezoidal prism. The cargo compartment 104 could have at least one curved surface. In some embodiments of the invention, the cargo compartment 104 is loaded with cargo without using a smart box 106 or smart pallet 108 or using at least one smaller sized (relative to the exemplary full-size box depicted in FIG. 8) smart box.

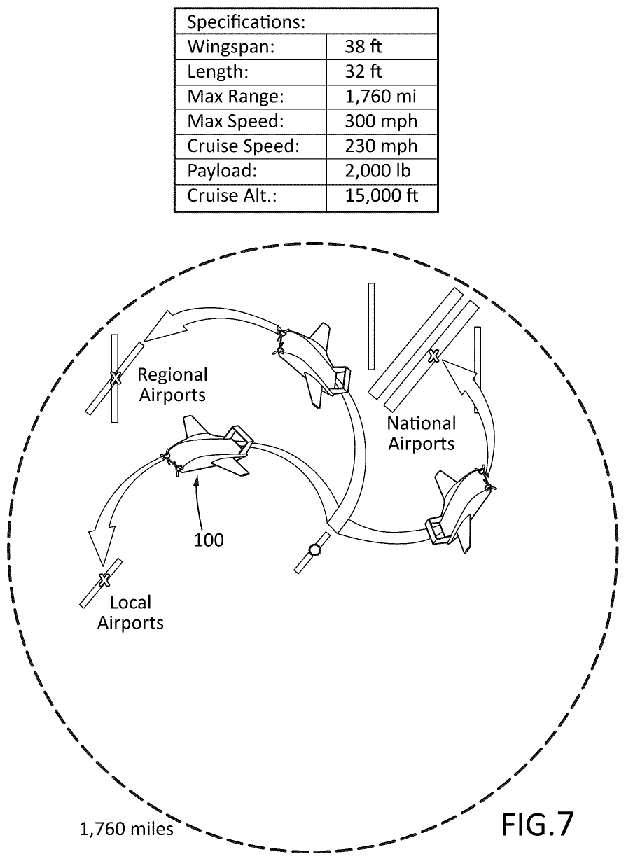

FIG. 7 shows exemplary specifications and use scenarios of the aircraft 100 of a cargo container system, in accordance with an embodiment of the invention. It should be understood that these values are by way of example only. For example, the cruise altitude could be higher or lower depending on the use scenario and/or the system configuration (e.g. lower cruise altitude for a manned version of the aircraft 100 so a pressurized crew compartment is not required). As other examples, the range, max speed, cruise speed and/or payload could also differ.

FIG. 8 is a schematic showing exemplary specifications of an abstracted smart box 800 of a cargo container system, in accordance with an embodiment of the invention. It should be understood that these values are by way of example only. In certain use scenarios, it is expected that up to 2000 lbs (907.18 kg) of cargo, in up to 182 cu. ft. of volume, could be transported up to 1,500 mi (2414 km).

FIGS. 9A-9D are a top, perspective, front and side views, respectively, the smart box 106 of a cargo container system, in accordance with an embodiment of the invention. It should be understood that any shown specifications, dimensions and performance characteristics are by way of example only. FIG. 9A shows the top of the smart box 106, including at least one door 902 for accessing the interior of the smart box 106. While the at least one door 902 is shown on the top of the smart box 106, it should be understood that at least one door can be located on any of the sides and/or bottom in addition, in the alternative, and/or optionally.

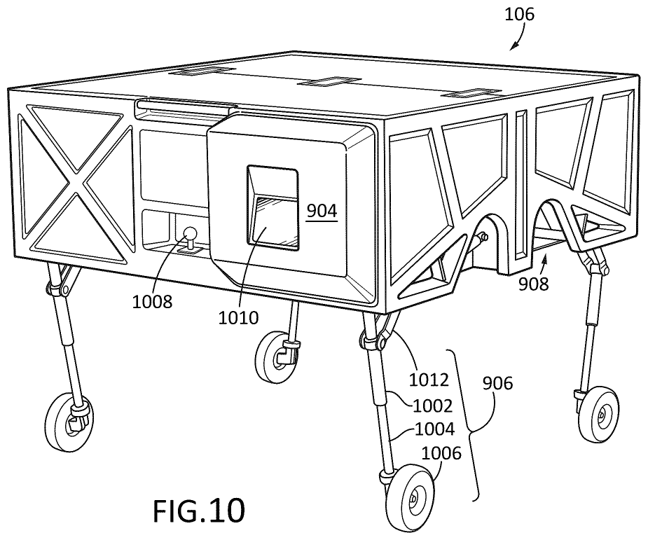

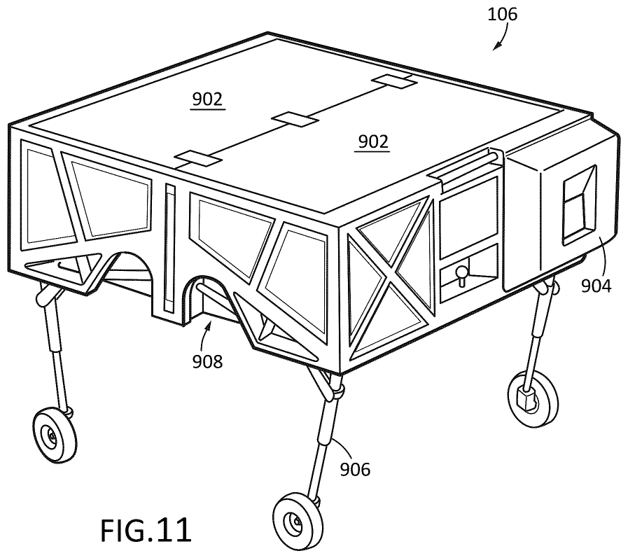

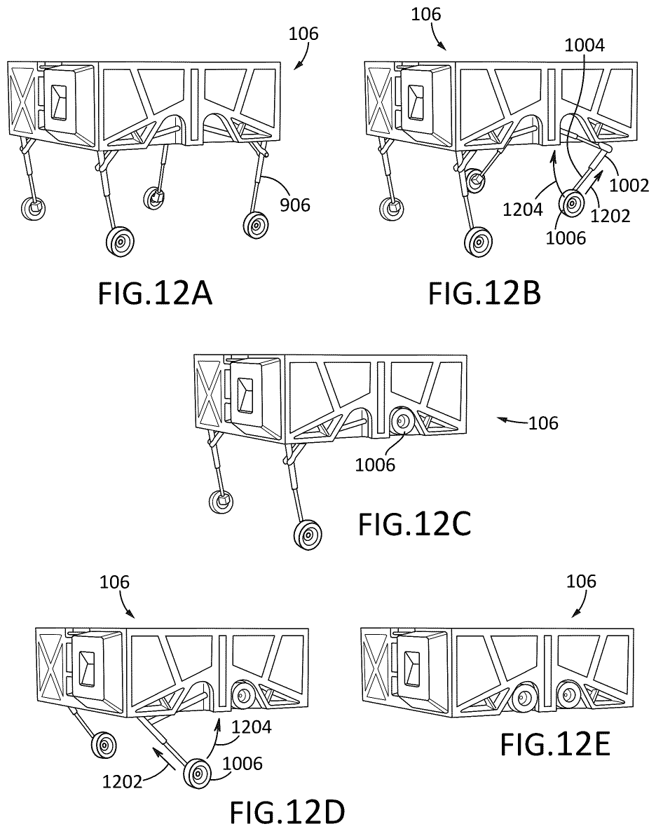

As will be described in more detail below, FIGS. 9B and 9D show the retracting/folding 1202, 1204 nature of the leg assemblies 906, comprising wheels 1006 and/or telescoping wheel struts 1002, 1004 and/or folding initiators 1012 (described in more detail with respect to FIGS. 10 and 12A-12E), according to an embodiment of the invention. In some embodiments of the invention, the wheels and/or the wheel strut retraction/folding/telescoping is mechanized. Optionally, two or more actuators are provided per strut/wheel. Additionally, alternatively and/or optionally, the wheel strut retraction/folding/telescoping is manual, for example, using an auxiliary gearbox to drive a leadscrew. In some embodiments of the invention, one or more wheels 1006 are motorized. In some embodiments of the invention, the leg assemblies 906 use some type of pinning system for safety and/or stability. In an embodiment of the invention, the leg assemblies 906 are retracted/folded 1202, 1204 into niches 908 which are sized/or and shaped to fully accommodate the struts 906, including the wheels 1006, such that the struts 906 are fully contained within the profile of the smart box 106, as shown in FIG. 9D.

In some embodiments of the invention, at least one wheel 1006 of the leg assemblies 906 uses a linkage which restricts back driving due to external force. In some embodiments of the invention, the struts have a vertical actuated degree of freedom to control the pitch, roll, yaw of the container (using the actuation of one or more of the struts). That is, the struts can independently extend and/or retract 1202 thereby lengthening and/or shortening. Optionally, the struts are telescoping 1202 and/or folding 1204. In an embodiments of the invention, actuators are used which are be able to lift a fully-loaded box from the ground to the smart box's highest position. Actuators are optionally EMA (electromechanical), with a possibility of EHA (electrohydrostatic) depending on loads/forces on the mechanisms. The smart box 106 can stop at any intermediate position in this vertical axis.

FIG. 9C shows a direct view of a user interface/touchscreen/panel 904 on the front of the box, in an exemplary embodiment of the invention. In some embodiments of the invention, the user interface 904 allows a user to control aspects of movement, loading, weight balance, open/closed, and/or other relevant operational characteristics of the smart box 106 and optionally, how the smart box 106 interfaces and/or interacts with the aircraft 100. For example, the loading of the smart box into the aircraft can be commenced using the user interface 904, in some embodiments of the invention. Other examples of available controls using the user interface could include deploying/retracting/extending the wheels and/or struts, inserting/withdrawing the box from the aircraft, raising/lowering the box relative to the ground (e.g. using the retractable feature of the wheel struts to extend/retract in length) and/or integrating data and/or operations from the smart box with the aircraft. In some embodiments of the invention, the user uses a joystick 1008 to drive the smart box 106 and/or load/unload the smart box into/from the aircraft 100.

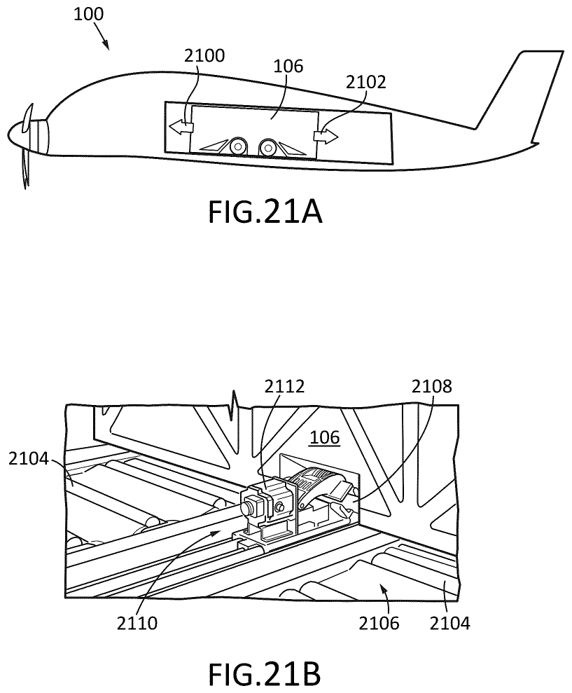

The user interface 904 allows the user to learn information about the system, for example, how much the box 106 weighs and/or its weight balance state (in one or more dimensions). In some embodiments of the invention, the smart box 106 is powered by an internal battery. Additionally, alternatively and/or optionally by an external power source, for example the smart box 106 is powered by the aircraft 100 when inserted therein and/or is powered by a ground power unit (“GPU”) or a ground transport vehicle, such as a tug. In some embodiments, the electrical interface between the smart box and the aircraft is combined with the mechanical means for adjusting its position within the cargo compartment, for example the leadscrew/clamp shown in FIG. 21.

While not shown, the box has integrated hitches, handles and/or loops and/or attachment points to make handling the box easier and/or more secure and/or more efficient, for example to attach boxes to each other and/or to attach a tug for pulling the smart box 106. In some embodiments, the attachment points are standard ground support equipment (GSE) attachment mechanisms.

In some embodiments of the invention, the “smart box” portion of the system is comprised of a plurality of smart boxes. The plurality of boxes are optionally of a known and/or standard size or sizes. Optionally, the boxes are configured with an attachment system wherein they can be reversibly secured to each other during transport. Optionally, the plurality of boxes, when attached to one another, assume the same shape and size as the prototypical smart box, for example as shown in FIG. 8. In some embodiments of the invention, the smart box 106 comprises one, some or all of the following features:
Robotic System automatically calculates payload weight and center of gravity (CG) location using onboard computer
Network of sensors and actuators integrated into the system
User interface panel provides information to ground crews during loading process
Interfaces to aircraft
   Automatic loading
   Automatic unloading
   Communicates CG of payload to autopilot/pilot
Contains onboard computer, battery and sensor network
System calculates CG based on feedback from load cells on each leg
System monitors position of each actuator/tilt of cargo box using onboard inertial measurement unit (IMU)
Strut lengths can be varied to control rotation of box relative to ground/aircraft (3 degrees of freedom control)
Aircraft/ground transport hardpoint attachment 2108 at front of box

FIG. 10 is a perspective view of the smart box 106 of a cargo container system, in accordance with an embodiment of the invention. In an embodiment of the invention, the smart box is provided with a controller, such as the user interface 904, optionally including a touchscreen 1010, a joystick 1008 and/or remote data input device 1505 like a tablet, for directing operations of the smart box 106 (for example, movement of the box in configurations where the wheels are motorized).

FIG. 11 is a perspective view of the smart box 106 of a cargo container system, in accordance with an embodiment of the invention. While two hinged doors 902 are shown, any configuration capable of opening and closing the smart box could be employed. In some embodiments of the invention, opening/closing of the doors is automated/motorized. In some embodiments of the invention, drop panels are provided to at least one side of the smart box to ease cargo loading and/or unloading. In some embodiments of the invention, drop panels and lowering the cargo box using the struts 906 ease cargo loading and/or unloading.

In some embodiments of the invention, at least one divider is provided to the interior of the smart box. It is conceived that this helps with cargo organization, reducing cargo shifting during transport, reducing damage to the cargo during transport, easing loading/unloading of the cargo (for example, at intermediate stops) and/or ensuring CG stability.

FIGS. 12A-12E show a sequence for placing a smart box 106 into a loading configuration for insertion into an aircraft 100 of a cargo container system, in accordance with an embodiment of the invention. While in some embodiments of the invention, the smart box is loaded and/or unloaded from the aircraft in a first mode, automatically, for example the extension/retraction 1202 and folding/unfolding 1204 of the wheels and/or wheel struts is automatic, in some embodiments, the same operations can be achieved in a second mode of operation, manually, for example using a hand crank to deploy/retract/extend/fold/unfold the wheels/struts. Similarly, while in the first mode (automatic) the box operates and/or communicates with the aircraft to load/unload itself (and its cargo) into/from the cargo compartment, in a second more conventional mode (manual) the loading/unloading is performed by hand and/or by a manually-operated mechanical means.

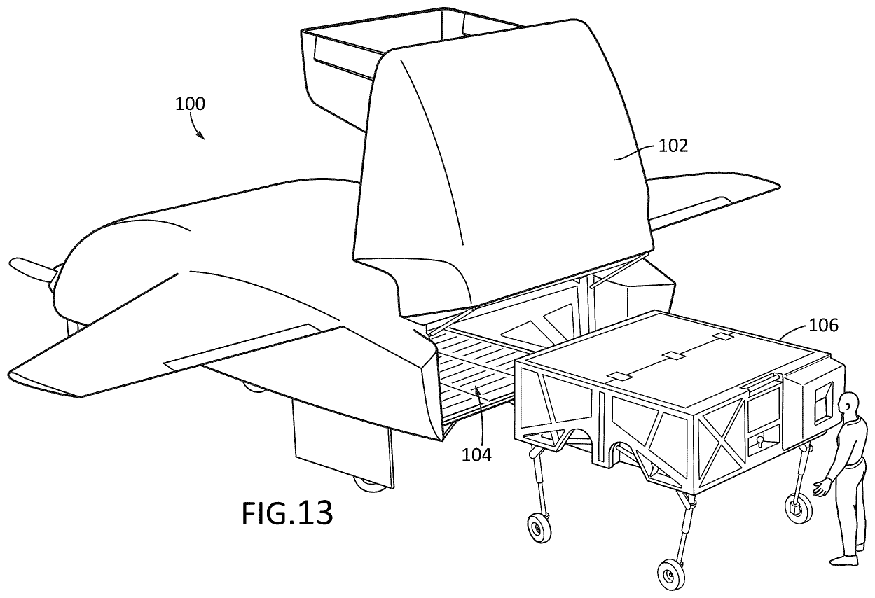

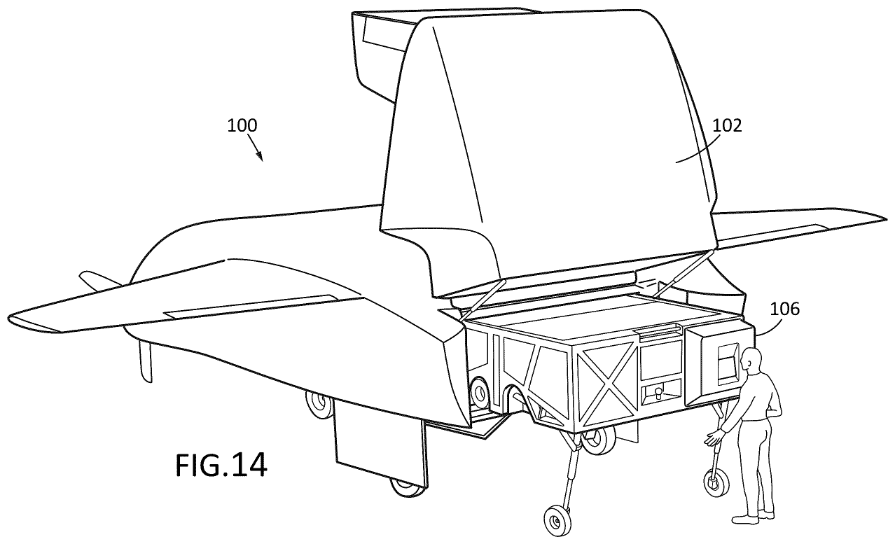

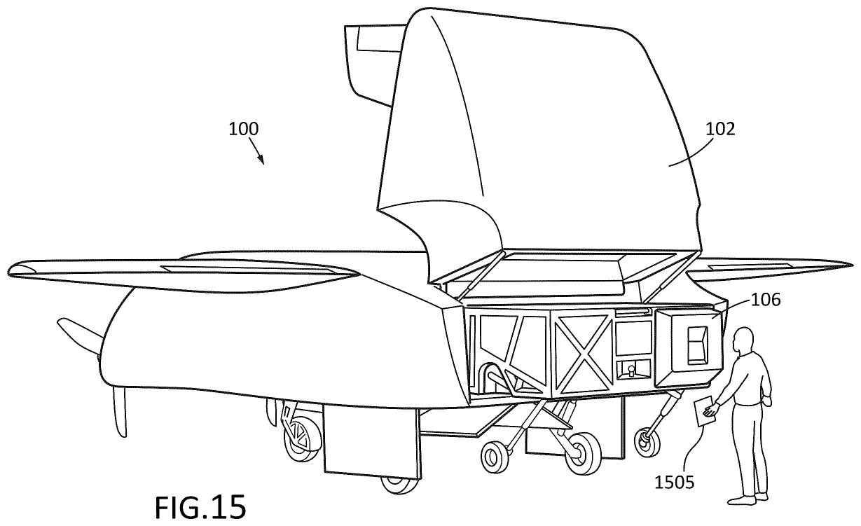

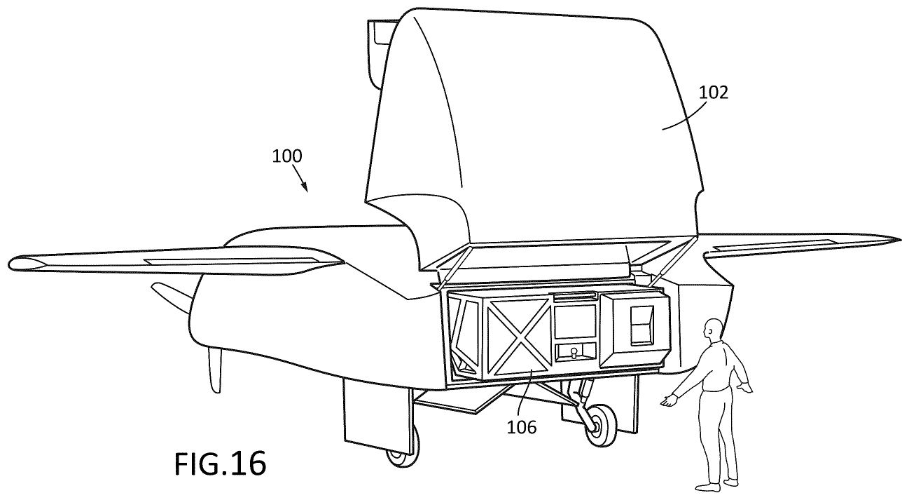

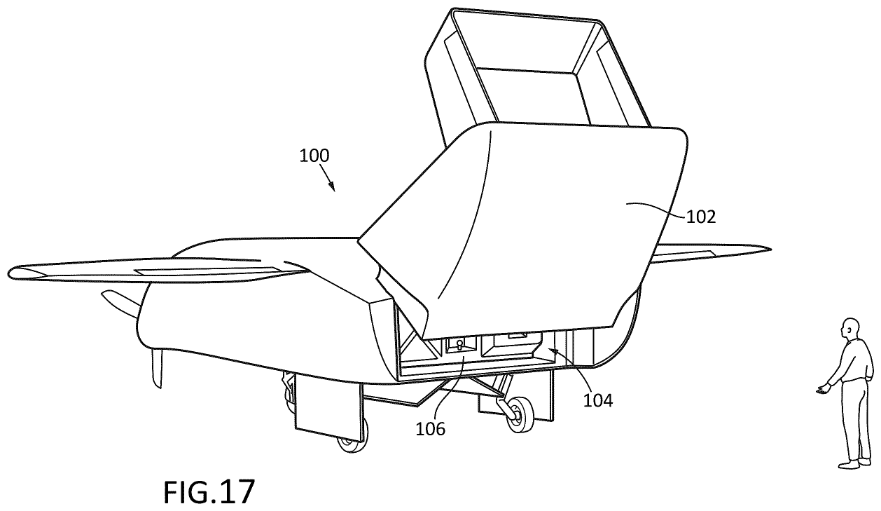

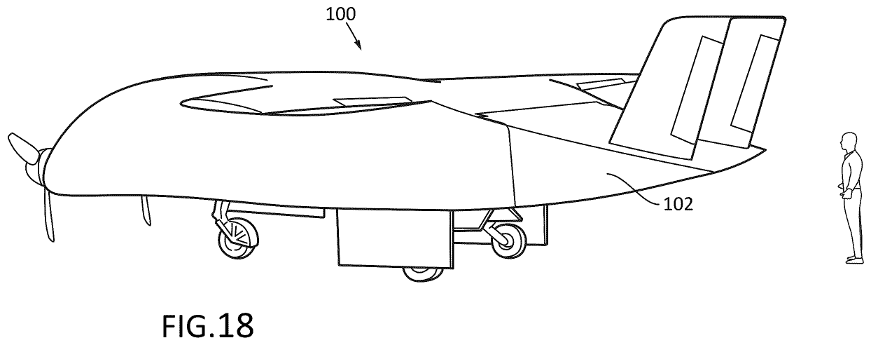

FIGS. 13-18 show a sequence of loading a smart box 106 into an aircraft 100 of a cargo container system, in accordance with an embodiment of the invention.

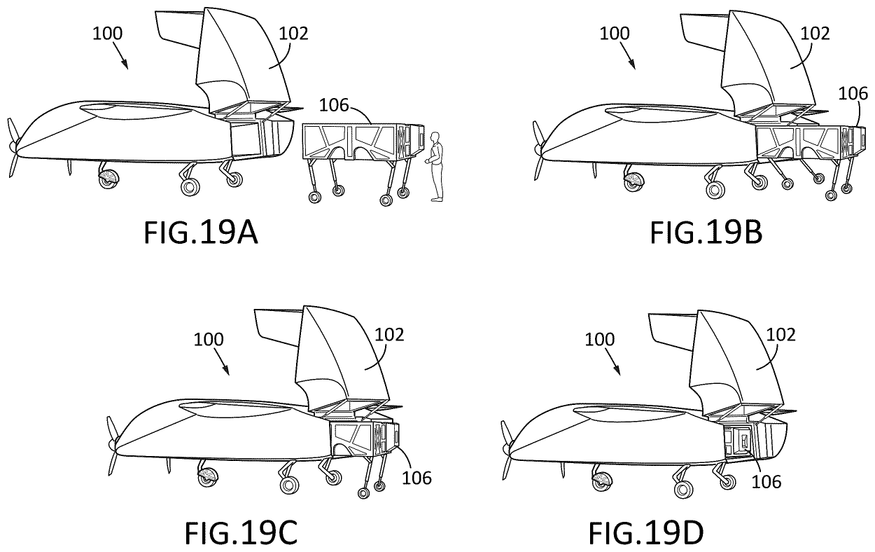

FIGS. 19A-19D show additional and/or alternative details, relative to FIGS. 13-18, of a sequence of loading a smart box 106 into an aircraft 100 of a cargo container system, in accordance with an embodiment of the invention. In an embodiment of the invention, the sequence comprises:
Smart box 106 approaches rear of aircraft 100. The user interface 904 and/or remote mobile device 1505 lets operator know when box is correctly positioned for loading sequence
Aircraft 100 attaches to hardpoint 2108 on box. The user interface alerts operator that box is attached to loading mechanism
Front struts retract/stow, providing a sleek exterior to the front side of the box 106 with the stowed wheels/struts. Operator selects next step in loading sequence on user interface
Box 106 is pulled into cargo compartment 104 halfway. Status is displayed on user interface, operator selects next step
Rear struts retract/stow, providing a sleek exterior to the rear side of the box 106 with the stowed wheels/struts. Status is displayed on user interface, operator selects next step
Smart box 106 is fully loaded into aircraft. Payload weight and CG is communicated to pilot/autopilot/aircraft 100
Aircraft 100 compares smart box data with its own load sensors to ensure data accuracy and safety of flight. It should be understood that the data is real-time data, in some embodiments of the invention.

In some embodiments of the invention, the smart box senses its proximity and/or orientation with respect to the aircraft and/or the cargo compartment and automatically maneuvers itself into an appropriate loading disposition in relation to the aircraft/cargo compartment. In some embodiments of the invention, the box automatically deploys itself (unloads itself) from the aircraft. Optionally, at the command of a user.

It should also be understood from the sequence described above, which could be fully automated without any user intervention, that the aircraft 100 is optionally provided with a processor/controller for performing such tasks as communicating with the smart box 106, the user, storing data, processing data, determining load balance, tracking loading/unloading status of the smart box, and other related tasks as are implicated by the description of the system herein. In some embodiments of the invention, the processor/controller and the sensors of the aircraft perform load balancing without input from the smart box 106 or the cargo in the compartment 104.

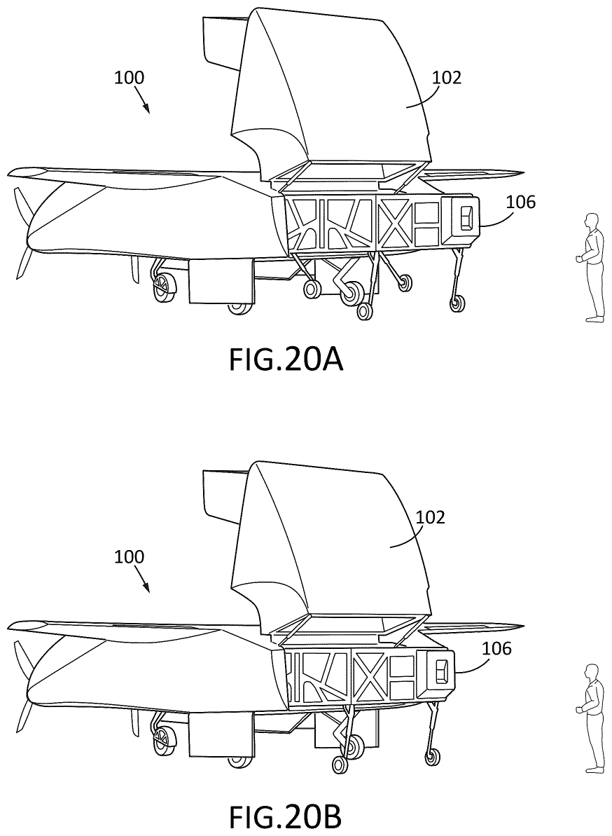

FIGS. 20A-20B show additional and/or alternative details of a sequence of loading a smart box into an aircraft of a cargo container system, for example the smart box 106 loading itself into the aircraft 100, in accordance with an embodiment of the invention.

FIG. 21A is a schematic of load balancing in the cargo container system, in accordance with an embodiment of the invention. As described elsewhere herein, the cargo container system is adapted with a weight balance adjustment mechanism to determine and/or adjust 2100, 2102 the CG of the overall system by adjusting the positioning the smart box within the aircraft, optionally in real time. As shown in FIG. 21B, in some embodiments:
The smart box 106 attaches to the aircraft using a shaft and lock system; and/or
smart box 106 slides on rolling guides 2104 on floor 2106 of the cargo compartment 104; and/or
The smart box 106 can translate fore 2100 and aft 2102 for weight and balance before, during and/or after takeoff, cruise and/or landing; and/or
The smart box 106 can move fore 2100 and aft 2102 during flight to help trim aircraft and reduce trim drag (increases fuel efficiency)

In some embodiments of the invention, smart box 106 position adjustment within the aircraft can be carried out using a screw assembly 2110 or a worm gear along with a motorized clamp 2112 for driving movement fore and aft while being attached to the hardpoint 2108 of the smart box 106.

In some embodiments of the invention, adjustments to weight balance can be determined by measuring flight characteristics of the aircraft (using elevator position, for example). One method of adjusting the pitch trim in flight is by knowing, in real time, the position of the aircraft's elevator. When the elevator is in the neutral position, the aircraft has the least pitch trim drag. At various altitudes, attitudes and configurations (flaps down, gear down etc.), the pitch trim of the aircraft has to be adjusted by moving the elevator to maintain the desired coordinated flight attitude. The system (e.g. controller+sensors of the aircraft 100) can monitor the pitch angle of the elevator and adjust the fore and aft position of the smart box 106 using the weight balance adjustment mechanism to minimize the elevator deflection from the neutral position which reduces the trim induced drag of the aircraft.

Additionally, alternatively and/or optionally, load sensors are integrated into the aircraft, for example in the aircraft wheels/landing gear, to determine weight balancing of the aircraft before and/or while loaded with the smart box. In some embodiments, the load sensors in the aircraft are used in conjunction with the load sensing/weight balance calculation of the smart box in order to position the smart box 106 within the aircraft at the desired location within the cargo compartment 104. In some embodiments, the wheel load sensors are backups to the smart box sensors and weight balance calculations. In some embodiments of the invention, for example where no smart box is used or in case of smart box sensor failure, the wheel load sensors are used exclusively.

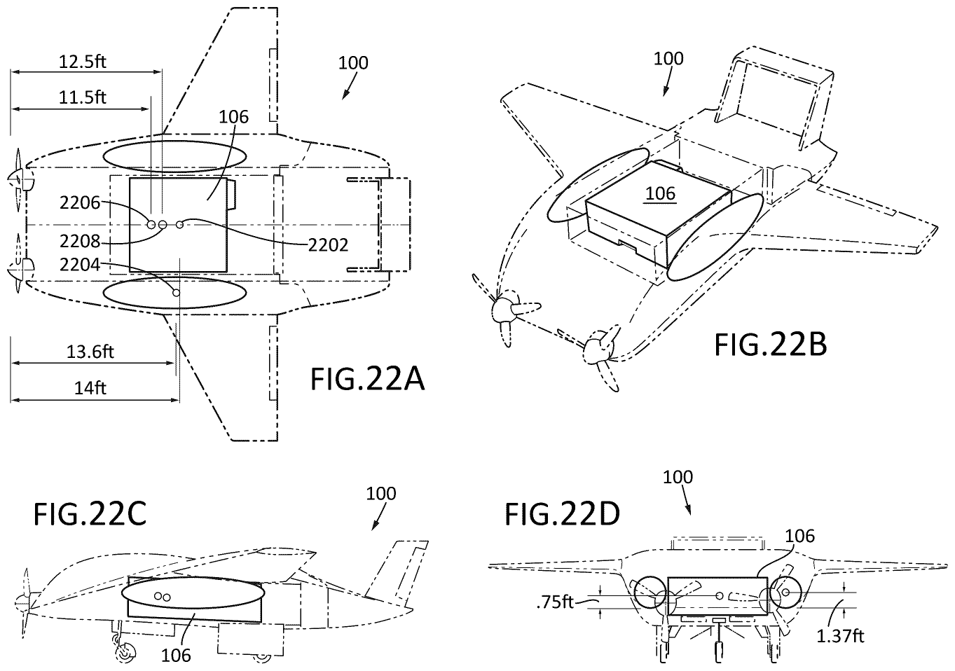

FIGS. 22A-22D show top, perspective, side and rear views, respectively, of exemplary trim/balance points which would be considered/processed by the cargo container system, in accordance with an embodiment of the invention. In an embodiments, these points are used for determining and/or adjusting weight balance in the system. In some embodiments of the invention, fuel-based CG is considered in combination with payload CG and the CG of the aircraft itself, in order to determine overall aircraft center of gravity. A cargo CG 2202 is shown, a fuel CG 2204, a fore CG 2206 of the aircraft and an aft CG 2208 of the aircraft are shown in FIG. 22A.

FIG. 22D demonstrates that CG is calculated not only in x,y axes but also in the z axis, in accordance with an exemplary embodiment of the invention.

With respect to this and other FIGS., the aircraft 100 is shown in hashed lines only for the purpose of focusing the figure on the load balancing aspects of FIGS. 22A-22D, it should be understood that the shape, dimensions and/or configuration of the aircraft 100 are considered as forming a part of the invention described herein, acting in concert with the smart box 106, and together forming the cargo container system, in some embodiments of the invention.

FIGS. 23A-23B are front and rear perspective views, respectively, of a smart pallet 108 of a cargo container system, in accordance with an embodiment of the invention. As can be seen in FIG. 23A, the smart pallet 108 is provided with a user interface 2300, not unlike user interface 904. In some embodiments of the invention, the smart pallet 108 is provided with grooves 2302 for use with a forklift or the like.

In some embodiments of the invention, the deck 2304 of the smart pallet 108 is provided with sensors, for example load and/or position sensors, for determining various information such as the mass and/or location of cargo loaded onto the deck 2304.

FIG. 24 is an exemplary loading scenario of a smart cargo container system using a smart pallet 108, in accordance with an embodiment of the invention.

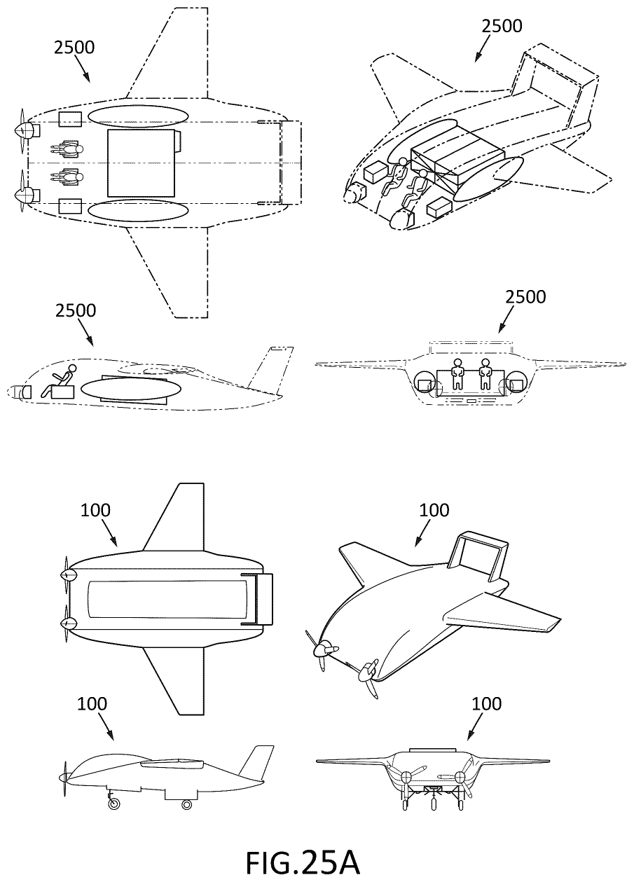

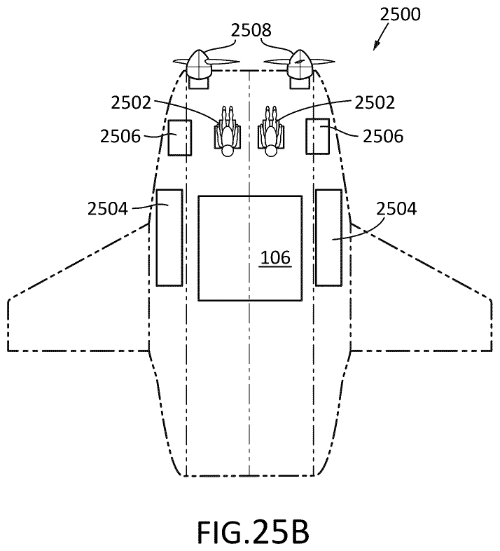

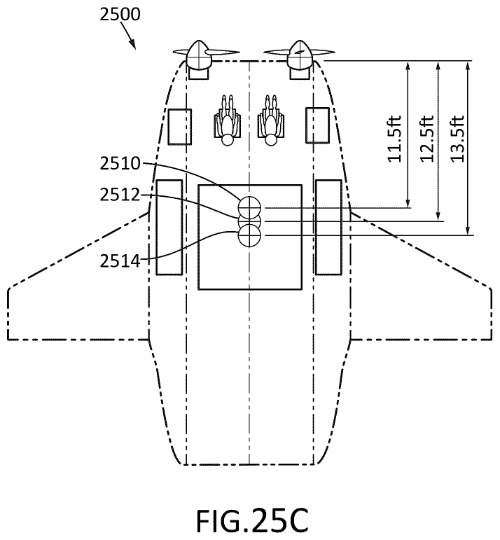

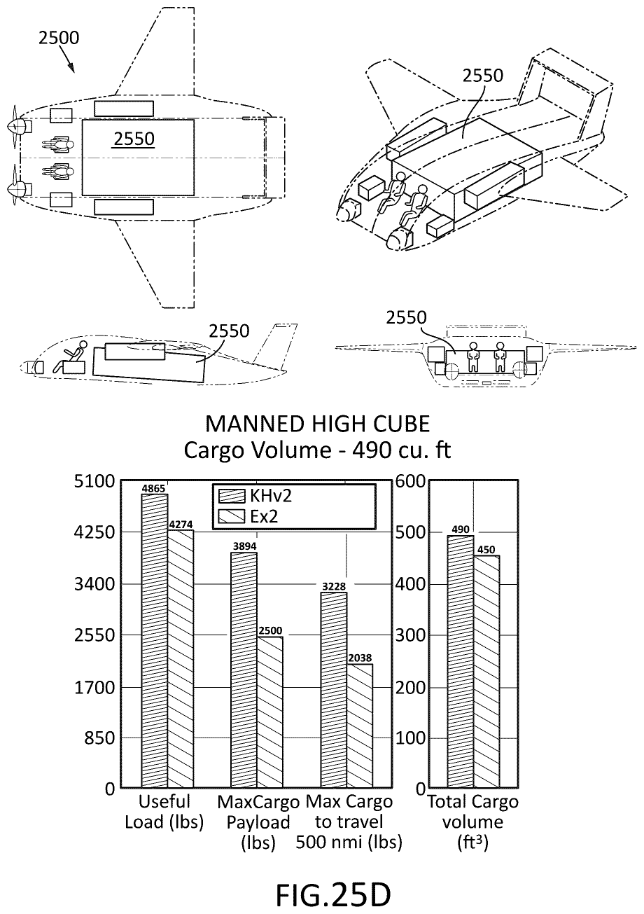

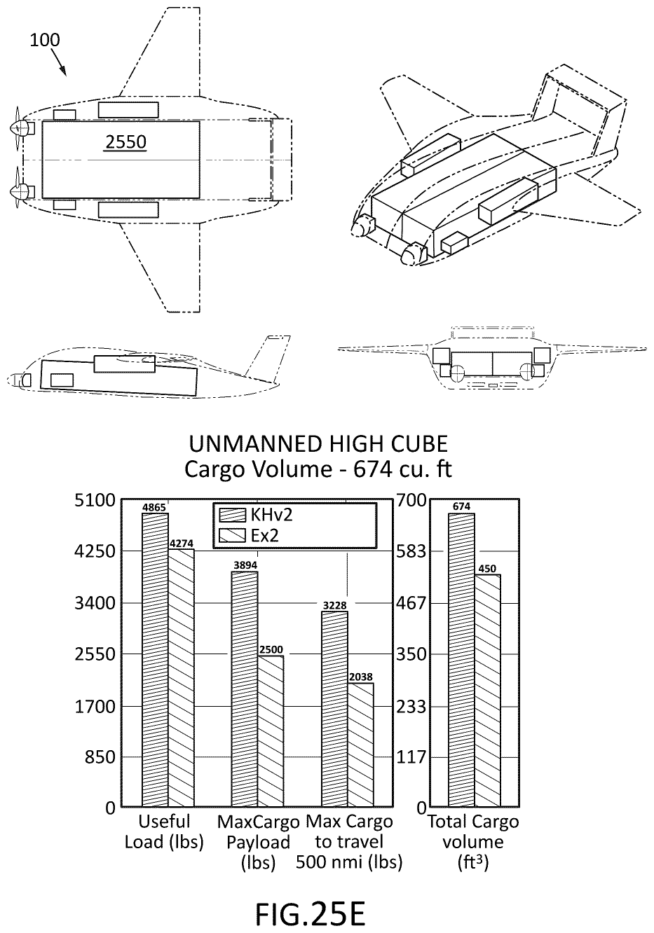

FIGS. 25A-E show exemplary cargo container system configurations and related performance/measurable characteristics, in accordance with embodiments of the invention. Exemplary configurations shown in FIG. 25A include a manned version of the cargo container system 2500 and an unmanned version 100.

FIG. 25B shows a schematic, top view of the manned version 2500 which includes at least one pilot 2502, at least one fuel tank 2504, at least one generator and/or engine 2506, and/or at least one motor 2508.

FIG. 25C shows CG calculations 2510, 2512 with a neutral point behind CG 2514 for the aircraft 2500, wherein the aircraft 100 maintains inherent stability, in accordance with some exemplary embodiments of the invention.

FIGS. 25 D and 25E show exemplary characteristics such as cargo volume, useful load, max cargo payload, and max cargo to travel 500 nm for manned 2500 and unmanned 100 using a high smart box 2550, in comparison to a common industry vehicle (Example 2, Grand Caravan).

In some embodiments, the cargo space fits within structural ribs of the aircraft.

In some embodiments of the invention, the tail section (or a cargo door thereof) is hinged in alignment with the trailing edge of the wing of the aircraft.

In some embodiments of the invention, the fuel tanks are centered around the design CG to eliminate CG shift due to fuel considerations.

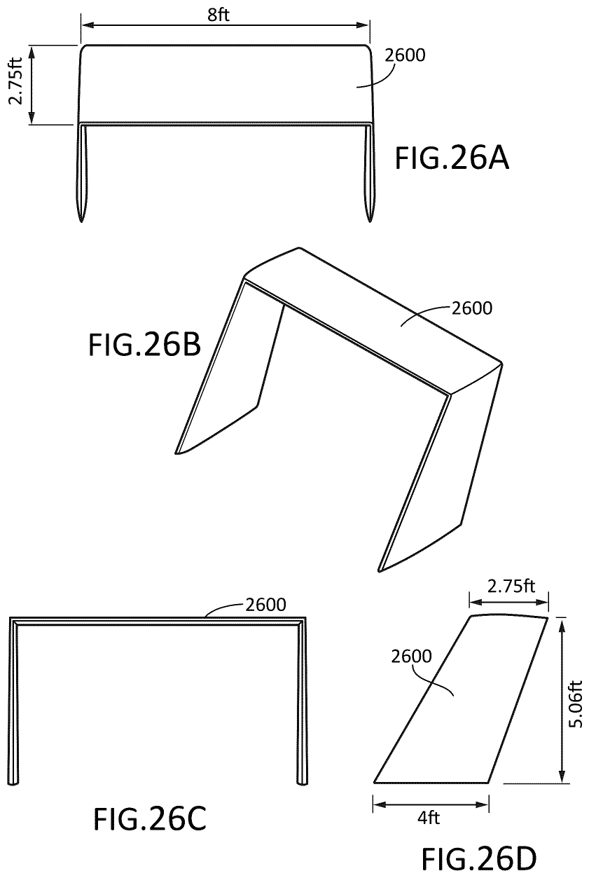

FIG. 26 shows an exemplary tail 2600 configuration for the aircraft 100, 2500, in accordance with an embodiment of the invention.

It is expected that during the life of a patent maturing from this application many relevant cargo boxes and aircraft will be developed and the scope of these terms is intended to include all such new technologies a priori.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

The term “plurality” means “two or more”.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A cargo container system, comprising:
a vehicle with a cargo compartment;
a cargo container configured to fit within the cargo compartment; and,
a weight balance adjustment mechanism, comprising at least one of a load sensor and a position sensor, configured to adjust the position of the cargo container within the cargo compartment using data received from the at least one of a load sensor and a position sensor.

2. The system according to claim 1, wherein the vehicle is an aircraft.

3. The system according to claim 1, wherein the cargo container is a box having an interior space with at least one door for accessing the interior space.

4. The system according to claim 1, wherein the cargo container is a pallet.

5. The system according to claim 1, wherein the weight balance adjustment mechanism comprises a controller for processing the data and/or at least partially automatically controlling the weight balance adjustment mechanism.

6. The system according to claim 1, wherein the cargo container further comprises a user interface configured to provide information regarding the system and control of the system to a user.

7. The system according to claim 1, wherein the cargo container comprises a plurality of wheels on an underside of the cargo container.

8. The system according to claim 7, wherein the wheels are attached to the cargo container by folding and/or retractable and expandable struts.

9. The system according to claim 7, wherein the wheels are motorized.

10. The system according to claim 8, wherein the folding and/or retractable/expandable struts are actuated.

11. The system according to claim 1, wherein the weight balance adjustment mechanism is configured to adjust the position of the cargo container while the vehicle is still or in motion based on the data.

12. The system according to claim 1, wherein the at least one of a load sensor and a position sensor is disposed on the vehicle, on the cargo container or both.

13. The system according to claim 1, further comprising an integrated power source.

14. The system according to claim 1, wherein the cargo container is at least partially automatically loaded into the cargo compartment.

15. The system according to claim 1, wherein the weight balance adjustment system comprises a screw-based movement mechanism.

16. The system according to claim 1, further comprising an electro-mechanical interface between the cargo container and the vehicle.

17. A method of using a cargo container system, comprising:
placing cargo into a cargo container;
inserting the cargo container into a cargo compartment of a vehicle; and,
adjusting the weight balance of the cargo container within the cargo compartment using a weight balance adjustment mechanism comprising at least one of a load sensor and a position sensor, configured to adjust the position of the cargo container within the cargo compartment using data received from the at least one of a load sensor and a position sensor.

18. The method according to claim 17, further comprising calculating the weight balance state of the cargo container prior to inserting.

19. The method according to claim 17, wherein at least one of inserting and adjusting is performed at least partially automatically.

20. The method according to claim 17, wherein the adjusting is performed using data derived from at least one of the cargo container and the vehicle.
